(19) United States
(12) Patent Application Publication
(10) Pub. No.: US 2025/0138549 A1
(43) Pub. Date: May 1, 2025

(54) MOBILE OBJECT CONTROL DEVICE, MOBILE OBJECT CONTROL SYSTEM, AUTOMATED TRANSPORTATION SYSTEM, AND MOBILE OBJECT CONTROL METHOD

(71) Applicant: MITSUBISHI ELECTRIC CORPORATION, Tokyo (JP)

(72) Inventors: Naoki TAKAHASHI, Tokyo (JP); Ryosuke MAEMURA, Tokyo (JP); Nariaki TAKEHARA, Tokyo (JP); Ken HIKASA, Tokyo (JP); Kohei MORI, Tokyo (JP)

(73) Assignee: MITSUBISHI ELECTRIC CORPORATION, Tokyo (JP)

(21) Appl. No.: 18/813,251

(22) Filed: Aug. 23, 2024

(30) Foreign Application Priority Data
Oct. 31, 2023 (JP) 2023-186389

(51) Int. Cl. G05D 1/633; G05D 1/248; G05D 1/646; G05D 105/20; G05D 109/10; G05D 111/30

(52) U.S. Cl. CPC G05D 1/633; G05D 1/248; G05D 1/646; G05D 2105/20; G05D 2109/10; G05D 2111/32

(57) ABSTRACT

The mobile object control device includes: a prescribed path information acquisition unit which acquires prescribed path information; an obstacle information acquisition unit which acquires obstacle information; a position orientation information acquisition unit which acquires position orientation information; and a traveling path determination unit which judges whether or not a vehicle is traveling on a prescribed path, and judges whether or not there is a possibility that the vehicle collides with an obstacle, and then, if it is judged that there is the possibility of the collision, determines whether or not to cause the vehicle to travel on a prescribed-path-outside traveling path.

### BACKGROUND OF THE INVENTION

### 1. Field of the Invention

The present disclosure relates to a mobile object control device, a mobile object control system, an automated transportation system, and a mobile object control method.

### 2. Description of the Background Art

As a method for causing a mobile object such as a vehicle to travel at a factory, a normal road, or the like, a path guide method is known. In the path guide method, an electromagnetic guide wire or a magnetic marker is buried in the ground along a prescribed path set in advance, and a mobile object travels on the prescribed path by being guided by the electromagnetic guide wire or the like.

In Patent Document 1, in a case where the electromagnetic guide wire cannot be used because of disconnection or the like, it is possible to travel on a prescribed path on the basis of road surface texture information acquired in advance and road surface texture information that is being used.

In Patent Document 2, in controlling the velocity of a mobile object on the basis of an actual traveling distance, a magnetic marker buried in a road surface on a prescribed path is used. That is, during traveling on the prescribed path, an actual traveling distance is estimated from a physical quantity related to rotation of a wheel, the estimated value of the actual traveling distance is corrected using the magnetic marker buried in the road surface on the prescribed path, and then a control quantity for the mobile object is determined on the basis of the corrected actual traveling distance. Thus, it is possible to freely change a position for performing a command for the velocity of the mobile object, without removing existing magnetic markers and installing magnetic markers again.
Patent Document 1: WO2019/054438
Patent Document 2: WO2019/026921

In a case where an obstacle is present on a prescribed path, a mobile object needs to travel outside the prescribed path at least temporarily in order to avoid the obstacle. However, the technologies in the above Patent Documents have difficulties in achieving such operation. For example, in the technology in Patent Document 1, texture information on a road surface is used, and outside the prescribed path, unlike on the prescribed path, an enormous amount of road surface texture information is needed, so that the load for acquiring the road surface texture information and performing processing thereon might be excessive. Even in a case where a plurality of prescribed paths are set in advance, it is not always possible to find a time and a specific location when and where an obstacle appears on each prescribed path. Therefore, it is difficult to acquire road surface texture information including the positions of obstacles in advance and select an appropriate traveling path (including outside of a prescribed path) in response to obstacles on prescribed paths, and in a case where an obstacle is present on a prescribed path, it is difficult to switch the traveling path and avoid the obstacle. In the technology in Patent Document 2, magnetic markers are not buried outside a prescribed path, and it is impossible to correct an estimated value of an actual traveling distance as in a case of being on a prescribed path. Therefore, outside a prescribed path, the control quantity for the mobile object cannot be determined on the basis of the corrected actual traveling distance. Even in a case where a plurality of prescribed paths are set in advance, there is a problem similar to the case of Patent Document 1. That is, since it is difficult to bury magnetic markers correspondingly to obstacles in advance, it is difficult to select an appropriate traveling path (including outside of a prescribed path) in response to obstacles on prescribed paths, and in a case where an obstacle is present on a prescribed path, it is difficult to switch the traveling path and avoid the obstacle.

The present disclosure has been made to solve the above problems, and an object of the present disclosure is to provide a mobile object control device, a mobile object control system, an automated transportation system, and a mobile object control method that, for a mobile object traveling on a prescribed path, in a case where an obstacle is present on the prescribed path, can switch the traveling path from the prescribed path to outside of the prescribed path, thus avoiding the obstacle.

### SUMMARY OF THE INVENTION

A mobile object control device according to the present disclosure includes: a prescribed path information acquisition unit which acquires prescribed path information indicating whether or not a mobile object as a control target is traveling on a prescribed path; an obstacle information acquisition unit which acquires obstacle information which is information about an obstacle including presence/absence of the obstacle on the prescribed path; a position orientation information acquisition unit which acquires position orientation information indicating a position and an orientation of the mobile object; and a traveling path determination unit which judges whether or not the mobile object is traveling on the prescribed path, on the basis of the prescribed path information, and judges whether or not there is a possibility that the mobile object collides with the obstacle, and then, if it is judged that there is the possibility of the collision, determines whether or not to switch a traveling path of the mobile object from the prescribed path so as to cause the mobile object to travel on a traveling path other than the prescribed path.

A mobile object control method according to the present disclosure includes: a prescribed path information acquisition step of acquiring prescribed path information indicating whether or not a mobile object as a control target is traveling on a prescribed path; an obstacle information acquisition step of acquiring obstacle information which is information about an obstacle including presence/absence of the obstacle on the prescribed path; a position orientation information acquisition step of acquiring position orientation information indicating a position and an orientation of the mobile object; and a traveling path determination step of judging whether or not the mobile object is traveling on the prescribed path, on the basis of the prescribed path information, and judging whether or not there is a possibility that the mobile object collides with the obstacle, and then, if it is judged that there is the possibility of the collision, determining whether or not to switch a traveling path of the mobile object from the prescribed path so as to cause the mobile object to travel on a traveling path other than the prescribed path.

The mobile object control device, the mobile object control system, the automated transportation system, or the mobile object control method according to the present disclosure makes it possible to, for a mobile object traveling on a prescribed path, in a case where an obstacle is present on the prescribed path, switch the traveling path from the prescribed path to outside of the prescribed path, thus avoiding the obstacle.

### BRIEF DESCRIPTION OF THE DRAWINGS

FIG. 1 illustrates a traveling path of a vehicle according to the first embodiment of the present disclosure;

FIG. 2 is a function block diagram showing a mobile object control device in the first embodiment;

FIG. 3 is a function block diagram of a traveling path determination unit according to the first embodiment;

FIG. 4 shows an example of a hardware configuration of the mobile object control device in the first embodiment;

FIG. 5 is a flowchart showing operation of the mobile object control device in the first embodiment;

FIG. 6 is a flowchart showing a reliability calculation step according to the first embodiment;

FIG. 7 is a flowchart showing operation in prescribed-path-outside traveling according to the first embodiment;

FIG. 8 is a function block diagram showing a mobile object control device in the second embodiment of the present disclosure;

FIG. 9 is a function block diagram showing a traveling path determination unit according to the second embodiment;

FIG. 10 is a flowchart showing operation of the mobile object control device in the second embodiment;

FIG. 11 is a flowchart showing operation in prescribed-path-outside traveling according to the second embodiment;

FIG. 12 shows the outline of a mobile object control system in the third embodiment of the present disclosure;

FIG. 13 is a function block diagram showing the mobile object control system in the third embodiment;

FIG. 14 is a function block diagram showing a traveling path determination unit according to the third embodiment;

FIG. 15 is a flowchart showing operation of the mobile object control system in the third embodiment;

FIG. 16 is a function block diagram showing a mobile object control system in a modification of the third embodiment;

FIG. 17 shows the outline of an automated transportation system in the fourth embodiment of the present disclosure; and

FIG. 18 is a function block diagram showing a management server according to the fourth embodiment.

### DETAILED DESCRIPTION OF THE PREFERRED EMBODIMENTS OF THE INVENTION

### First Embodiment

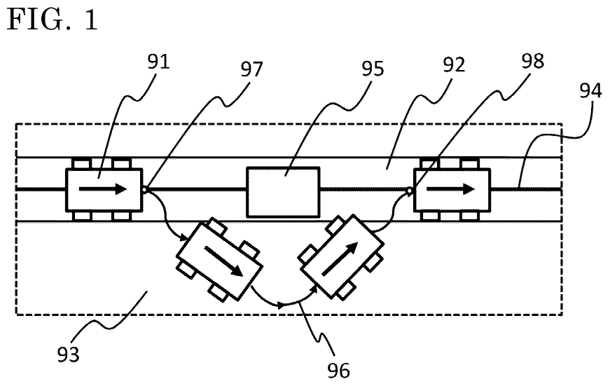

Hereinafter, the first embodiment of the present disclosure will be described with reference to FIG. 1 to FIG. 7. First, the outline of a mobile object control device of the first embodiment will be described. A mobile object control device of the present disclosure is used in a specific area such as a factory or an area including a normal road, and is mounted to a vehicle (i.e., a mobile object) traveling on a prescribed path set in advance, to control traveling of the vehicle. Normally, the vehicle travels on the prescribed path, but in a case where an obstacle is present on the prescribed path and traveling of the vehicle is obstructed by the obstacle, the vehicle travels outside the prescribed path at least temporarily, to avoid the obstacle.

The “mobile object” in each embodiment of the present disclosure is a mobile object that can travel on a prescribed path or outside the prescribed path, and examples of the mobile object include a golf cart, an automobile, an automated driving bus, a transportation vehicle, and a small-sized automated electric vehicle.

“Obstacles” in each embodiment of the present disclosure include not only stationary obstacles that do not move but also movable obstacles such as a person, another vehicle, a large-sized bus, and a truck.

The “prescribed path” in each embodiment of the present disclosure is a traveling path set in advance for the mobile object to perform automated travel thereon. Traveling of the mobile object on the prescribed path is referred to as “prescribed path traveling”.

“Automated traveling” in each embodiment of the present disclosure refers to traveling without an operator and without operation for increase/decrease of the velocity and steering. Here, the operator may be an occupant, a driver, or the like.

The “outside of a prescribed path” in each embodiment of the present disclosure is a traveling path other than the prescribed path or an area other than the prescribed path, on which the mobile object travels. Traveling of the mobile object outside a prescribed path is referred to as “prescribed-path-outside traveling”.

FIG. 1 illustrates a traveling path of a vehicle according to the first embodiment. Normally, a vehicle 91, i.e., a mobile object, performs prescribed path traveling. That is, the vehicle 91 travels on a prescribed path 92. An arrow in the vehicle 91 indicates the advancement direction of the vehicle. An area outside the prescribed path 92 is a prescribed-path-outside area 93. Traveling on the prescribed path 92 is achieved by an electromagnetic guide wire 94, for example. The electromagnetic guide wire 94 is buried under a road surface substantially at the center of the prescribed path 92, and allows the vehicle 91 to travel on the prescribed path 92 by the path guide method. In FIG. 1, an example in which the electromagnetic guide wire 94 is used is shown, but traveling on the prescribed path 92 may be achieved using radio frequency identification (RFID). In a case of controlling traveling of the vehicle 91 using a sensor such as the RFID or the electromagnetic guide wire 94, it is generally known that the position of the vehicle can be estimated with high accuracy and with a low load. The same applies in a case of performing traveling on the prescribed path 92 using a traveling road surface texture captured by a camera or buried magnetic markers, instead of a method using a sensor such as the RFID or the electromagnetic guide wire 94.

In a case where an obstacle 95 is present in front of the vehicle 91 on the prescribed path and traveling of the vehicle 91 on the prescribed path is obstructed, the vehicle 91 performs prescribed-path-outside traveling to avoid the obstacle 95. That is, the vehicle 91 travels on a prescribed-path-outside traveling path 96 in the prescribed-path-outside area and thus avoids the obstacle 95 while continuing traveling. After traveling on the prescribed-path-outside traveling path 96 at least temporarily, the vehicle 91 returns to the prescribed path 92. In FIG. 1, when a front end of the vehicle 91 reaches a deviation point 97, the traveling path of the vehicle 91 is switched to the prescribed-path-outside traveling path 96, and the traveling path of the vehicle 91 is returned to the prescribed path 92 at a return point 98.

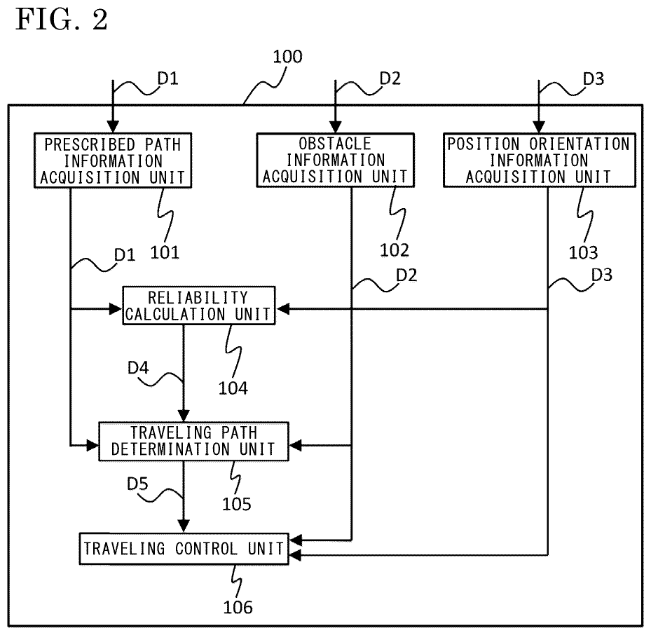

FIG. 2 is a function block diagram showing the mobile object control device in the first embodiment. A mobile object control device 100 is mounted to the vehicle 91 and includes a prescribed path information acquisition unit 101, an obstacle information acquisition unit 102, a position orientation information acquisition unit 103, a reliability calculation unit 104, a traveling path determination unit 105, and a traveling control unit 106.

The prescribed path information acquisition unit 101 acquires prescribed path information D1 and outputs the acquired prescribed path information D1 to the reliability calculation unit 104 and the traveling path determination unit 105. The prescribed path information acquisition unit 101 may have any configuration that can acquire information for whether or not the vehicle 91 is performing automated traveling on the prescribed path 92. Although not shown, for example, the prescribed path information acquisition unit 101 may be formed by a sensor that can recognize an electromagnetic guide wire, a road surface image, a buried marker, landmark information, an RFID, or the like, a vehicle velocity sensor that can acquire velocity information of the vehicle 91, an acceleration sensor that can acquire acceleration information of the vehicle 91, or a combination thereof. The prescribed path information acquisition unit 101 can acquire the magnitude of displacement in the transverse direction of the vehicle 91 (displacement in the direction perpendicular to the direction along the prescribed path 92 and the electromagnetic guide wire 94 in FIG. 1) from the electromagnetic guide wire 94 or a road surface image of the prescribed path 92. The prescribed path information acquisition unit 101 can acquire fixed point information such as absolute position information (latitude information and longitude information for the vehicle 91 and the prescribed path 92) for the vehicle 91 and the prescribed path 92 and relative position information for the vehicle 91 and the prescribed path 92, from a sensor such as a buried marker, landmark information, or an RFID. The input and the output of the prescribed path information acquisition unit 101 may be different in data format, but the substantial content of the information is the same therebetween and therefore is referred to as the prescribed path information D1 for both of the input and the output.

The velocity information of the vehicle 91 may be acquired by the vehicle velocity sensor or may be acquired by integrating, with respect to time, an acceleration acquired by an acceleration sensor, and includes information on the velocity value of the vehicle 91. The velocity value and the position information of the prescribed path 92 are combined to acquire a relative position on the prescribed path 92. An offset value for the velocity of the vehicle 91 can be acquired from a sensor such as a buried magnetic marker, landmark information, or an RFID. Therefore, the velocity value is corrected by the offset value as necessary. The “offset value for the velocity of the vehicle 91” is a velocity value acquired by the vehicle velocity sensor when the vehicle 91 is stopped, and is used for correcting the velocity information of the vehicle 91. Specifically, the offset value is added to or subtracted from the velocity value obtained by the vehicle velocity sensor, thus obtaining an actual velocity value.

The acceleration sensor is an acceleration sensor that outputs a signal indicating a detected acceleration, and detects an acceleration that arises in the frontward/rearward direction of the vehicle 91. The acceleration sensor may detect accelerations in the width direction and/or the upward/downward direction of the vehicle, in addition to the acceleration in the frontward/rearward direction.

The prescribed path information D1 is information indicating whether or not the vehicle 91 is performing automated traveling on the prescribed path 92. The prescribed path information D1 includes the magnitude of displacement in the transverse direction of the vehicle 91 from the electromagnetic guide wire 94 or a road surface image of the prescribed path 92, an offset amount from a buried magnetic marker, and the fixed point position information on the prescribed path 92, which can be acquired by any means. The fixed point position information on the prescribed path 92 includes the latitude information and the longitude information of the vehicle 91 and the relative position information of the vehicle 91 (information for the relative position on the prescribed path 92), as described above. Further, the prescribed path information D1 may include position information for complementing the fixed point position information on the prescribed path 92. Such complementary position information can be acquired from a sensor mounted to the vehicle 91, or the like, and includes, for example, position information calculated from velocity information of the vehicle 91 acquired by the vehicle velocity sensor of the vehicle 91.

In a case of judging whether or not the vehicle 91 is performing automated driving on the prescribed path 92 from the prescribed path information D1, whether or not displacement in the transverse direction of the vehicle 91 from the electromagnetic guide wire 94 is greater than the width in the transverse direction of the prescribed path 92, is judged, for example. In a case where the vehicle 91 is not displaced from the electromagnetic guide wire 94, or the vehicle 91 is displaced but the magnitude of the displacement is smaller than the width of the prescribed path 92, it is judged that the vehicle 91 is performing automated traveling on the prescribed path 92. On the other hand, in a case where the vehicle 92 is displaced from the electromagnetic guide wire 94 by an amount not less than the width of the prescribed path 92, it is judged that the vehicle 91 is not performing automated traveling on the prescribed path 92.

The obstacle information acquisition unit 102 acquires obstacle information D2 and outputs the acquired obstacle information D2 to the traveling path determination unit 105 and the traveling control unit 106. The obstacle information acquisition unit 102 may have any configuration that can detect whether or not the obstacle 95 is present on the prescribed path 92 through which the vehicle 91 is traveling, and is formed by, for example, a sensor for detecting a state around the vehicle 91, or the like. Examples of such a sensor include a sonar, a millimeter-wave radar, or a camera. The input and the output of the obstacle information acquisition unit 102 may be different in data format, but the substantial content of the information is the same therebetween and therefore the information is referred to as the obstacle information D2 for both of the input and the output.

The obstacle information D2 is information detected by a sensor or the like forming the obstacle information acquisition unit 102. The obstacle information D2 includes information about whether or not the obstacle 95 is present, the position of the obstacle 95, the direction and the distance of the obstacle 95 from the vehicle 91, whether or not the obstacle 95 is moving, the size of the obstacle 95, the object type, and the like. In a case where the obstacle 95 is moving, information about the movement direction, the velocity, and the acceleration of the obstacle 95 is also included in the obstacle information D2.

The position orientation information acquisition unit 103 acquires position orientation information D3 and outputs the acquired position orientation information D3 to the reliability calculation unit 104 and the traveling control unit 106. The input and the output of the position orientation information acquisition unit 103 may be different in data format, but the substantial content of the information is the same therebetween and therefore the information is referred to as the position orientation information D3 for both of the input and the output.

The position orientation information D3 is information indicating the position and the orientation of the vehicle 91, and includes position information and orientation information of the vehicle 91. The position information of the vehicle 91 is acquired by a global navigation satellite system (GNSS), for example. The orientation information of the vehicle 91 is acquired using an inertia measurement unit (IMU), for example. The details about acquisition of the position information and the orientation information of the vehicle 91 will be described later.

The position orientation information acquisition unit 103 has a configuration for acquiring the absolute position of the vehicle 91 and a configuration for acquiring the orientation of the vehicle 91, by a GNSS sensor, for example. In recent years, for the GNSS sensor, a multi-GNSS has been generally used with increase in satellite systems. The GNSS sensor of the position orientation information acquisition unit 103 includes a multi-GNSS antenna for receiving radio waves radiated from a plurality of GNSS satellites present above the own vehicle (vehicle 91). The plurality of GNSS satellites include at least a global positioning system (GPS) satellite. In addition, a satellite such as a quasi-zenith satellite (QZS), a global navigation satellite system (GLONASS) satellite, a BeiDou satellite, or a Galileo satellite may be included. The multi-GNSS may output a positioning calculation result obtained through positioning calculation in the GNSS sensor to a corresponding receiver (multi-GNSS receiver), or may output GNSS observed data before positioning calculation as raw data.

As a method for positioning calculation by the GNSS sensor, various methods can be used, e.g., single positioning, differential GPS (DGPS) positioning, real time kinematic (RTK) positioning, or network RTK positioning, may be used.

The single positioning is a type of positioning method for performing positioning using pseudo range observed values received from four or more positioning satellites.

Examples of the DGPS positioning include a satellite-based augmentation system (SBAS) and a centimeter level augmentation service (CLAS). The DGPS positioning is a positioning method in which positioning calculation is performed using augmentation data for satellite positioning error which can be generated from a GPS-based control station and a private fixed station, thus obtaining a satellite positioning result having higher accuracy than in the single positioning.

The RTK positioning is a positioning method in which satellite raw data from a GPS-based control station and a private fixed station are transferred to a mobile station to remove an error factor of a satellite positioning result near a base station, and enables satellite positioning with high accuracy. In the RTK positioning, when an integer variable called ambiguity is found with high accuracy, positioning with accuracy of centimeter level is achieved. The positioning solution at this time is called Fix solution. If ambiguity is not found, a positioning solution called Float solution which has lower accuracy is obtained. The Float solution converges to the Fix solution over time.

The network RTK positioning is a positioning method in which satellite positioning data corresponding to a case where a base station is provided (virtual reference point data) is acquired through transmission/reception of communication data using a network, to perform positioning with high accuracy.

As described above, the position orientation information acquisition unit 103 also has a configuration for acquiring orientation information of the vehicle 91. As the configuration for acquiring orientation information of the vehicle 91, for example, an IMU provided with a gyro sensor may be used. The gyro sensor detects rotational angular velocities about the yaw axis, the pitch axis, and the roll axis of the vehicle 91, and outputs signals indicating the detected rotational angular velocities, to a positioning device such as the IMU. Since the gyro sensor detects the rotational angular velocity about the yaw axis, i.e., a yaw rate, the gyro sensor serves as a yaw rate sensor. The orientation information of the vehicle 91 is obtained on the basis of the yaw rate calculated from the output of the gyro sensor. In a case where accuracy of the position information acquired by the GNSS as described above is low, the position information and the orientation information may be combined to enhance accuracy of the position information. As an alternative for the position information by the GNSS, the orientation information may be used.

The reliability calculation unit 104 receives the prescribed path information D1 and the position orientation information D3, and outputs a reliability D4 calculated on the basis of the prescribed path information D1 and the position orientation information D3, to the traveling path determination unit 105. The reliability D4 is an index for evaluating accuracy of the position orientation information D3. The reliability calculation unit 104 compares the position information of the prescribed path 92 included in the prescribed path information D1 and the position information of the vehicle 91 (e.g., position information based on the GNSS) included in the position orientation information D3, and calculates the reliability D4 on the basis of the relationship of the above information. More specifically, the reliability D4 is calculated on the basis of a difference between the absolute position of the vehicle 91 indicated by the prescribed path information D1 and the absolute position of the vehicle 91 indicated by the position orientation information D3. As the difference becomes greater, the reliability D4 is set to be smaller, and as the difference becomes smaller, the reliability D4 is set to be greater. The absolute position of the vehicle 91 based on the prescribed path information D1 may be calculated from a track of the vehicle 91 acquired from the fixed point position information of the vehicle 91 included in the prescribed path information D1. Thus, the absolute position of the prescribed path 92 is also acquired.

In the first embodiment, the reliability D4 is calculated on the basis of the position information of the vehicle 91, but the reliability D4 may be calculated on the basis of the orientation of the vehicle 91. In this case, the orientation information of the vehicle 91 is also included in the prescribed path information D1. The orientation information of the vehicle 91 based on the prescribed path information D1 may be acquired from a track of the vehicle 91, as in the case of the absolute position.

The traveling path determination unit 105 receives the prescribed path information D1, the obstacle information D2, and the reliability D4, and determines whether or not to switch the traveling path of the vehicle 91 from the prescribed path 92 to the prescribed-path-outside traveling path 96, i.e., another traveling path. The traveling path determination unit 105 outputs the determination result as a traveling path determination result D5 to the traveling control unit 106.

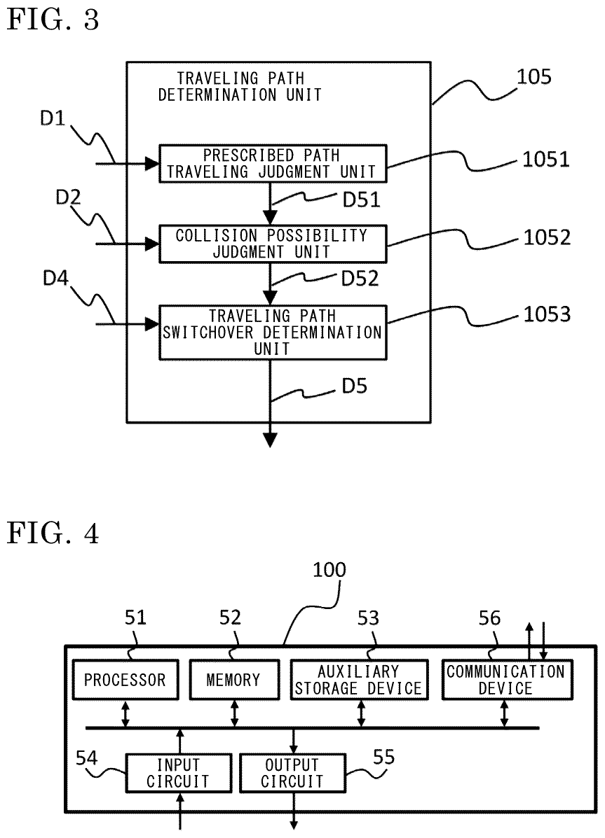

The traveling path determination unit 105 will be further described. FIG. 3 is a function block diagram showing the traveling path determination unit according to the first embodiment. The traveling path determination unit 105 includes a prescribed path traveling judgment unit 1051, a collision possibility judgment unit 1052, and a traveling path switchover determination unit 1053.

The prescribed path traveling judgment unit 1051 receives the prescribed path information D1, and judges whether or not the vehicle 91 is traveling on the prescribed path 92, on the basis of the prescribed path information D1. The prescribed path traveling judgment unit 1051 may also acquire information such as the position, the vehicle velocity, the acceleration, the orientation, and the like of the vehicle 91 on the prescribed path 92, from the prescribed path information D1. The prescribed path traveling judgment unit 1051 outputs a judgment result as to whether or not the vehicle 91 is traveling on the prescribed path 92, as a prescribed path traveling judgment result D51, to the collision possibility judgment unit 1052.

The collision possibility judgment unit 1052 receives the obstacle information D2 and the prescribed path traveling judgment result D51, and judges whether or not there is a possibility that the vehicle 91 traveling on the prescribed path 92 collides with the obstacle 95, on the basis of the obstacle information D2 and the prescribed path traveling judgment result D51. In a case where the vehicle 91 is not traveling on the prescribed path 92, and in a case where the vehicle 91 is traveling on the prescribed path 92 but the obstacle 95 is absent on the prescribed path 92, the collision possibility judgment unit 1052 judges that there is no possibility that the vehicle 91 collides with the obstacle 95. In a case where the vehicle 91 is traveling on the prescribed path 92 and the obstacle 95 is present on the prescribed path 92, the collision possibility judgment unit 1052 compares the position, the velocity, the acceleration, and the orientation of the vehicle 91 at the time of the judgment with the position, the size, the velocity, the acceleration, and the orientation of the obstacle 95, to judge the possibility that the vehicle 91 collides with the obstacle 95. In a case where the obstacle 95 is present at the rear of the vehicle 91, it is judged that there is no possibility of collision. In a case where the obstacle 95 is present in front of the vehicle 91, it may be judged that there is a possibility of collision or it may be judged that there is no possibility of collision, on the basis of the relationship of the amount of displacement in the transverse direction of each of the vehicle 91 and the obstacle 95 from the prescribed path 92 and the size (transverse width) of each of the vehicle 91 and the obstacle 95.

In judging the possibility of collision between the vehicle 91 and the obstacle 95, the collision possibility judgment unit 1052 may calculate a margin time or a margin distance until collision. The collision possibility judgment unit 1052 outputs a judgment result for the possibility of collision between the vehicle 91 and the obstacle 95, as a collision possibility judgment result D52, to the traveling path switchover determination unit 1053. In a case where the margin time or the margin distance is calculated, this information is also included in the collision possibility judgment result D52 and outputted to the traveling path switchover determination unit 1053.

The traveling path switchover determination unit 1053 receives the reliability D4 and the collision possibility judgment result D52, and if it is judged that there is a possibility of collision between the vehicle 91 and the obstacle 95 on the basis of the collision possibility judgment result D52, the traveling path switchover determination unit 1053 determines whether or not to switch the traveling path of the vehicle 91 from the prescribed path 92 so as to cause the vehicle 91 to travel on the prescribed-path-outside traveling path 96. In a case where there is no possibility of collision between the vehicle 91 and the obstacle 95, the traveling path switchover determination unit 1053 does not switch the traveling path of the vehicle 91 and keeps the traveling path of the vehicle 91 remaining the prescribed path 92.

In determining whether or not to switch the traveling path of the vehicle 91, the traveling path switchover determination unit 1053 performs determination on the basis of not only the collision possibility judgment result D52 but also information about the reliability D4. That is, even in a case where there is a possibility of collision between the vehicle 91 and the obstacle 95, the traveling path switchover determination unit 1053 determines whether or not to switch the traveling path of the vehicle 91, in accordance with the reliability D4. In a case where the reliability D4 is small and thus accuracy of the position orientation information D3 is insufficient, the traveling path switchover determination unit 1053 determines not to switch the traveling path of the vehicle 91, i.e., determines to keep the traveling path of the vehicle 91 remaining the prescribed path 92. In a case where there is a possibility of collision between the vehicle 91 and the obstacle 95, and the reliability D4 is great, the traveling path switchover determination unit 1053 determines to switch the traveling path of the vehicle 91 from the prescribed path 92 to the prescribed-path-outside traveling path 96. The determination for whether or not to switch the traveling path of the vehicle 91 by the traveling path switchover determination unit 1053 is determination for which traveling path to select for the vehicle 91. The traveling path switchover determination unit 1053 outputs the determination result as the traveling path determination result D5 to the traveling control unit 106.

Regarding whether the reliability D4 is great or small, a threshold th1 (not shown) may be set in advance and determination may be performed on the basis of whether or not the reliability D4 is greater than the threshold th1.

In a case where there is a possibility of collision between the vehicle 91 and the obstacle 95 but the traveling path is not switched (is kept remaining the prescribed path 92) because the reliability D4 is small, collision between the vehicle 91 and the obstacle 95 is avoided by means such as stopping the vehicle 91.

In a case where the margin time or the margin distance until collision between the vehicle 91 and the obstacle 95 is calculated by the collision possibility judgment unit 1052, the traveling path switchover determination unit 1053 may set the position of the deviation point 97 in accordance with the margin time or the margin distance. A specific path for the prescribed-path-outside traveling path 96 and the return point 98 may be set (or provisionally set) by the traveling path switchover determination unit 1053 in advance (before the traveling path is actually switched). Thus, the timing of generating a specific path for the prescribed-path-outside traveling path 96 may be the same as the timing of determining the traveling path by the traveling path determination unit 105, or may be any timing during prescribed-path-outside traveling. Prescribed-path-outside traveling may be performed while the prescribed-path-outside traveling path 96 already set is being corrected in accordance with the situation. A specific path generation method for the prescribed-path-outside traveling path 96 is not particularly limited. Any prescribed-path-outside traveling path 96 may be set as long as avoidance of the obstacle 95, deviation from the prescribed path 92, and return to the prescribed path 92 can be realized.

In a case where the margin time or the margin distance is short, the vehicle 91 has already come close to the obstacle 95, and thus it is determined that the vehicle 91 cannot avoid the obstacle 95 even if the vehicle 91 performs prescribed-path-outside traveling. Also in this case, the traveling path switchover determination unit 1053 determines not to perform switchover to the prescribed-path-outside traveling path 96. Thus, collision between the vehicle 91 and the obstacle 95 is avoided by means such as stopping the vehicle 91. Determination for whether or not the margin time or the margin distance is small is performed on the basis of whether or not the margin time or the margin distance is smaller than a predetermined threshold th2 (not shown). The threshold th2 is set on the basis of the sizes of the vehicle 91 and the obstacle 95, and the turning performance of the vehicle 91. In a case where the vehicle 91 and the obstacle 95 are small and the turning performance of the vehicle 91 is high, the threshold th2 can be set to be smaller.

The traveling control unit 106 receives the obstacle information D2, the position orientation information D3, and the traveling path determination result D5, and controls traveling of the vehicle 91. In a case where the vehicle 91 travels on the prescribed path 92 on the basis of the traveling path determination result D5, the traveling control unit 106 controls prescribed path traveling of the vehicle 91 by prescribed path traveling control. In the prescribed path traveling control, the traveling control unit 106 controls traveling of the vehicle 91 on the prescribed path by being guided by the electromagnetic guide wire 94, for example. In a case where the vehicle 91 travels on the prescribed-path-outside traveling path 96 on the basis of the traveling path determination result D5, the traveling control unit 106 controls prescribed-path-outside traveling of the vehicle 91 by prescribed-path-outside traveling control. In the prescribed-path-outside traveling control, the traveling control unit 106 controls traveling of the vehicle 91 on the basis of the position orientation information D3.

In the prescribed-path-outside traveling control, first, prescribed path deviation control is performed. This is control for changing the orientation of the vehicle 91 at the deviation point 97 so as to switch the traveling path of the vehicle 91 from the prescribed path 92 to the prescribed-path-outside traveling path 96, as shown in FIG. 1.

While the prescribed-path-outside traveling is being performed, the traveling control unit 106 controls traveling of the vehicle 91 on the basis of the position orientation information D3, and judges whether or not it is possible to return to the prescribed path 92, while acquiring the obstacle information D2 as appropriate. While presence of the obstacle 95 is confirmed in front of the vehicle 91, the traveling control unit 106 judges that it is impossible to return to the prescribed path 92, and continues performing the prescribed-path-outside traveling. If it is confirmed that the obstacle 95 is not present in front of the vehicle 91, the traveling control unit 106 performs return to the prescribed path 92. The traveling control unit 106 sets the return point 98 on the prescribed path, and causes the vehicle 91 to perform prescribed-path-outside traveling, heading toward the return point 98. In a case where the return point 98 is set in advance, it is not necessary to newly set the return point 98.

In the first embodiment, no matter which traveling path the vehicle 91 travels on, the traveling control unit 106 performs traveling control of the vehicle 91. However, between the prescribed path traveling control in a case of traveling on the prescribed path 92 and the prescribed-path-outside traveling control in a case of traveling on the prescribed-path-outside traveling path 96, a control method in traveling control and data needed in traveling control may be different. Therefore, instead of the traveling control unit 106, a prescribed path traveling control unit for performing traveling control in prescribed path traveling and a prescribed-path-outside traveling control unit for performing traveling control in prescribed-path-outside traveling may be provided.

In the first embodiment, also during the prescribed-path-outside traveling, a reliability D4* (not shown) is calculated and prescribed-path-outside traveling control is performed while accuracy of the position orientation information D3 is evaluated. During the prescribed-path-outside traveling, the reliability D4 cannot be calculated through comparison between the prescribed path information D1 and the position orientation information D3. Therefore, for example, the reliability D4* during the prescribed-path-outside traveling is calculated on the basis of the following.
(1) The number of satellites in the GNSS
(2) Comparison between a relative position calculated by an inertial navigation device and a position determined by the GNSS
(3) Dilution of precision (DOP)
(4) An S/N ratio of a navigation signal from each satellite
(5) Pseudo range residual, i.e., position error
(6) The elevation of a navigation satellite
(7) Orientation error obtained from comparison between an orientation acquired by a gyro sensor and an orientation acquired by the GNSS

The reliability D4* calculated during prescribed-path-outside traveling is used in judgment for whether or not it is possible to return to the prescribed path 92, for example. That is, even in a case where the obstacle 95 is absent in front of the vehicle 91 and the prescribed-path-outside traveling is close to an end, if the reliability D4* is not greater than a predetermined threshold th1*, return to the prescribed path 92 is not performed. In a case of returning to the prescribed path 92 when the reliability D4* is small, there is a possibility of causing such a problem that the vehicle 91 moves in an unintentional direction, for example. Performing judgment using the reliability D4* before returning to the prescribed path 92 can prevent such a situation as described above. When it is judged that the reliability D4* is small, the prescribed-path-outside traveling is continued or the vehicle 91 is stopped outside the prescribed path. Thereafter, the reliability D4* may be regularly calculated, and when it is judged that the reliability D4* is great (the reliability D4* is greater than the threshold th1*), return to the prescribed path 92 may be performed.

Next, a hardware configuration for implementing the functions of the mobile object control device 100 will be described. FIG. 4 shows an example of a hardware configuration of the mobile object control device in the first embodiment. The mobile object control device 100 is mainly composed of a processor 51, a memory 52 as a primary storage, and an auxiliary storage device 53. The processor 51 is formed by a central processing unit (CPU), an application specific integrated circuit (ASIC), a digital signal processor (DSP), or a field programmable gate array (FPGA), for example. The memory 52 is formed by a volatile storage device such as a random access memory, and the auxiliary storage device 53 is formed by a nonvolatile storage device such as a flash memory, a hard disk, or the like. The auxiliary storage device 53 stores a predetermined program to be executed by the processor 51. The processor 51 reads and executes the program as appropriate, to perform various calculation processing. At this time, the predetermined program is temporarily stored into the memory 52 from the auxiliary storage device 53, and the processor 51 reads the program from the memory 52. Calculation processing by the functions of the mobile object control device 100 is implemented by the processor 51 executing the predetermined program as described above. A result of calculation processing by the processor 51 is stored into the memory 52 once, and then is stored into the auxiliary storage device 53 in accordance with the purpose of the executed calculation processing.

The mobile object control device 100 includes an input circuit 54 which receives various inputs from outside, an output circuit 55 for performing various outputs to outside, and a communication device 56 which performs transmission/reception of various communication data.

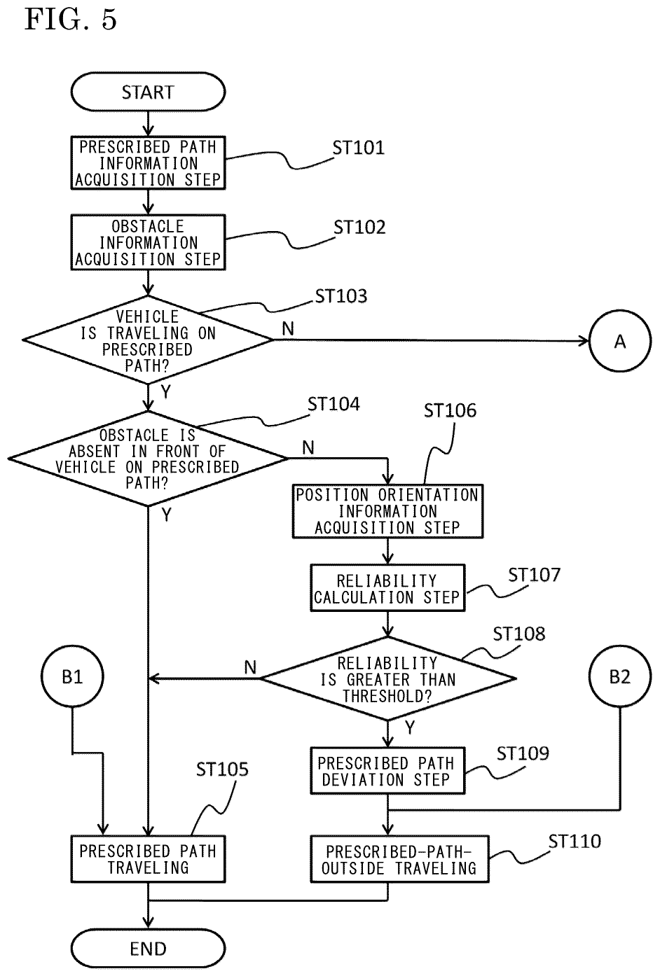

Next, operation will be described. FIG. 5 is a flowchart showing operation of the mobile object control device in the first embodiment, i.e., a mobile object control method. First, the prescribed path information D1 is acquired (step ST101: prescribed path information acquisition step).

Next, the obstacle information D2 is acquired (step ST102: obstacle information acquisition step).

Next, whether or not the vehicle 91 is traveling on the prescribed path 92 is judged on the basis of the prescribed path information D1, to obtain the prescribed path traveling judgment result D51 (step ST103: prescribed path traveling judgment step). If the vehicle 91 is traveling on the prescribed path 92, the process proceeds to step ST104, and if the vehicle 91 is not traveling on the prescribed path 92, the process proceeds to a terminal A. The terminal A is a start point for operation in prescribed-path-outside traveling. The operation in prescribed-path-outside traveling will be described later.

Next, whether or not there is a possibility that the vehicle 91 traveling on the prescribed path 92 collides with the obstacle 95 is judged on the basis of the obstacle information D2 and the prescribed path traveling judgment result D51 (step ST104: collision possibility judgment step). Here, for simplification of description, if the obstacle 95 is present in front of the vehicle 91 on the prescribed path, it is judged that there is a collision possibility, and if the obstacle 95 is absent in front of the vehicle 91, it is judged that there is no collision possibility. If an obstacle is absent in front of the vehicle on the prescribed path (there is no collision possibility), the process proceeds to step ST105, and if an obstacle is present in front of the vehicle on the prescribed path (there is a collision possibility), the process proceeds to step ST106.

If the vehicle 91 is traveling on the prescribed path 92 and it is judged that the obstacle 95 is absent in front of the vehicle 91 on the prescribed path, the prescribed path traveling is continued (step ST105).

If the vehicle 91 is traveling on the prescribed path 92 and it is judged that the obstacle 95 is present in front of the vehicle 91 on the prescribed path, the position orientation information D3 is acquired (step ST106: position orientation information acquisition step).

Next, the reliability D4 is calculated on the basis of the prescribed path information D1 and the position orientation information D3 (step ST107: reliability calculation step), to judge whether or not the reliability D4 is greater than the threshold th1 (step ST108). If the reliability D4 is greater than the threshold th1, it is judged that the reliability D4 is great, and the process proceeds to step ST109. If the reliability D4 is not greater than the threshold th1, it is judged that the reliability D4 is small, and the process proceeds to step ST105, to continue the prescribed path traveling. The details of the reliability calculation step will be described later.

If the reliability D4 is greater than the threshold th1, the vehicle 91 is deviated from the prescribed path 92, to switch the traveling path of the vehicle 91 to the prescribed-path-outside traveling path 96 (step ST109: prescribed path deviation step). Hereinafter, prescribed-path-outside traveling is performed (step ST110).

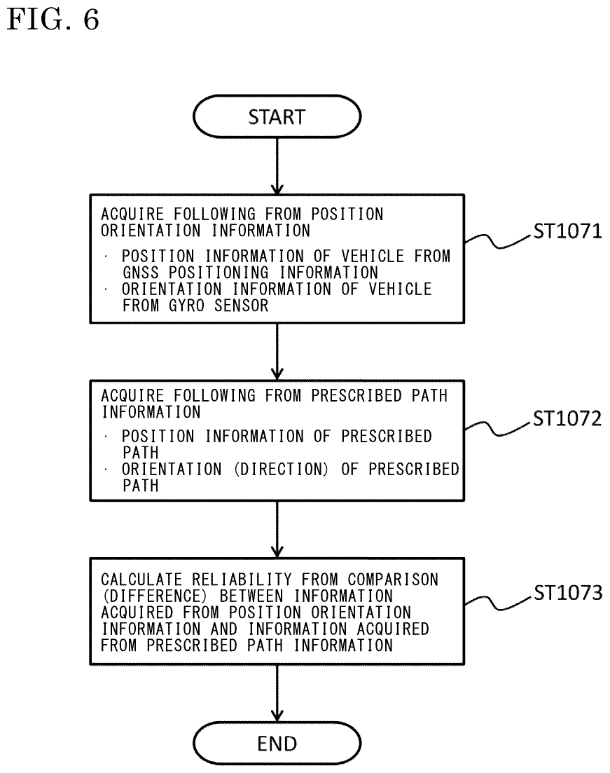

The details of the reliability calculation step will be described. FIG. 6 is a flowchart showing the reliability calculation step according to the first embodiment, and shows a calculation flow for the reliability D4 when the vehicle 91 is traveling on the prescribed path 92. FIG. 6 shows an example of the reliability calculation step, and if the reliability calculation method is changed, the flow is also changed accordingly.

First, position information (e.g., positioning information by the GNSS) of the vehicle 91 and orientation information (e.g., orientation information by a gyro sensor) of the vehicle 91 are acquired from the position orientation information D3 (step ST1071).

Next, position information of the prescribed path 92 and the orientation (direction) of the prescribed path 92 are acquired from the prescribed path information D1 (step ST1072). The orientation of the prescribed path 92 is a traveling direction of the vehicle 91 on the prescribed path 92 and is a direction in which the electromagnetic guide wire 94 extends.

Next, the position information of the vehicle 91 acquired in step ST1071 and the position information of the prescribed path 92 acquired in step ST1072 are compared with each other, to acquire a difference therebetween. In addition, the orientation information of the vehicle 91 acquired in step ST1071 and the orientation information of the prescribed path 92 acquired in step ST1072 are compared with each other, to acquire a difference therebetween. On the basis of the difference for the position information and the difference for the orientation information acquired as described above, the reliability D4 is calculated. If the vehicle 91 is traveling on the prescribed path 92, the position and the orientation of the vehicle 91 and the position and the orientation of the prescribed path 92 almost coincide with each other. Therefore, if accuracy of the position orientation information D3 is high, the difference from the prescribed path information D1 is small and thus the reliability D4 becomes great. This holds true in a case where accuracy of the prescribed path information D1 is sufficiently high. In this regard, it is considered that information based on the electromagnetic guide wire 94 or the like, such as the prescribed path information D1, has higher accuracy than information based on the GNSS or the like, such as the position orientation information D3. Here, the reliability D4 is calculated on the basis of both of the position information and the orientation information, but the reliability D4 may be calculated on the basis of only the position information.

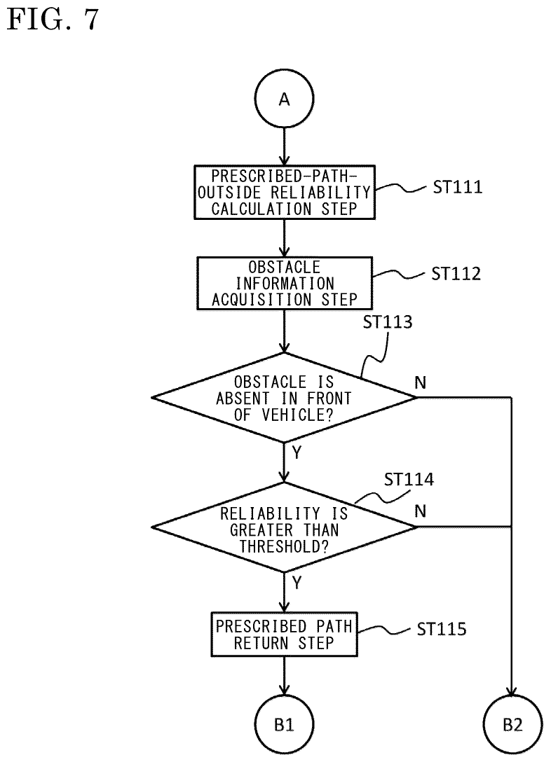

Next, operation in the prescribed-path-outside traveling will be described. FIG. 7 is a flowchart showing operation in the prescribed-path-outside traveling according to the first embodiment. First, the reliability D4* in the prescribed-path-outside traveling is calculated (step ST111: prescribed-path-outside reliability calculation step). The calculation method for the reliability D4* in the prescribed-path-outside traveling is as described above. That is, the reliability D4* is calculated on the basis of at least one of the number of satellites in the GNSS, comparison between a relative position calculated by an inertial navigation device and a position determined by the GNSS, DOP, an S/N ratio of a navigation signal from each satellite, pseudo range residual, the elevation of a navigation satellite, and orientation error (orientation error obtained from comparison between an orientation acquired by a gyro sensor and an orientation acquired by the GNSS).

Next, as in the case of the prescribed path traveling, the obstacle information D2 is acquired (step ST112: obstacle information acquisition step), and whether or not the obstacle 95 is absent in front of the vehicle 91 is judged on the basis of the obstacle information D2 (step ST113). If the obstacle 95 is absent in front of the vehicle 91, the process proceeds to step ST114. If the obstacle 95 is present in front of the vehicle 91, the vehicle 91 has not completed avoidance of the obstacle 95 yet, and therefore the process proceeds to a terminal B2, to continue the prescribed-path-outside traveling (see step ST110 in FIG. 5).

If the obstacle 95 is absent in front of the vehicle 91, it is judged that the vehicle 91 has already completed avoidance of the obstacle 95, and whether or not the reliability D4* is greater than the threshold th1* is judged (step ST114). If the reliability D4* is greater than the threshold th1*, it is judged that the reliability D4* is great, and the process proceeds to step ST115. If the reliability D4* is not greater than the threshold th1*, it is judged that the reliability D4* is small, and the process proceeds to the terminal B2, to continue the prescribed-path-outside traveling.

If it is judged that avoidance of the obstacle 95 has been completed and the reliability D4* is great, return to the prescribed path 92 is performed (step ST115: prescribed path return step). After the vehicle 91 is returned to the prescribed path 92, prescribed path traveling is to be performed, and therefore the process proceeds to a terminal B1, to perform prescribed path traveling (see step ST105 in FIG. 5).

According to the first embodiment, for a vehicle traveling on a prescribed path, in a case where an obstacle is present on the prescribed path, the traveling path can be switched from the prescribed path to outside of the prescribed path, thus avoiding the obstacle. More specifically, the mobile object control device includes: a prescribed path information acquisition unit which acquires prescribed path information indicating whether or not a vehicle as a control target is traveling on a prescribed path; an obstacle information acquisition unit which acquires obstacle information which is information about an obstacle including presence/absence of the obstacle on the prescribed path; a position orientation information acquisition unit which acquires position orientation information indicating a position and an orientation of the vehicle; and a traveling path determination unit which judges whether or not the vehicle is traveling on the prescribed path, on the basis of the prescribed path information, and judges whether or not there is a possibility that the vehicle collides with the obstacle, and then, if it is judged that there is the possibility of the collision, determines whether or not to switch a traveling path of the vehicle from the prescribed path so as to cause the vehicle to perform prescribed-path-outside traveling. As described above, the traveling path determination unit judges whether or not the vehicle is traveling on the prescribed path, and if the vehicle is traveling on the prescribed path, judges whether or not there is a possibility that the vehicle collides with the obstacle, and then, determines the traveling path on the basis of the two judgment results. Therefore, in a case where an obstacle is present on a prescribed path, the traveling path can be switched from the prescribed path to outside of the prescribed path, thus avoiding the obstacle.

In addition, it is possible to prevent prescribed-path-outside traveling from being performed on the basis of position orientation information having low accuracy. More specifically, the mobile object control device further includes a reliability calculation unit which calculates a reliability of the position orientation information on the basis of a relationship between the position of the vehicle and a position of the prescribed path. If the reliability is greater than a threshold, the traveling path determination unit causes the vehicle to perform the prescribed-path-outside traveling, and if the reliability is not greater than the threshold, the traveling path determination unit causes the vehicle to perform prescribed path traveling. As described above, the reliability indicates accuracy of the position orientation information. In addition, in a case where the traveling path of the vehicle is switched from the prescribed path to the prescribed-path-outside traveling path, traveling control based on the position orientation information is performed. If accuracy of the position orientation information is low, the prescribed-path-outside traveling of the vehicle is not appropriately performed, and the vehicle might collide with the obstacle because the vehicle cannot avoid the obstacle even through the prescribed-path-outside traveling or returns to the prescribed path at a timing that is too early, for example. In a case where the reliability is small and accuracy of the position orientation information is insufficient, the traveling path switchover determination unit does not switch the traveling path of the vehicle, and thus can prevent the prescribed-path-outside traveling from being performed on the basis of the position orientation information having low accuracy.

### Second Embodiment

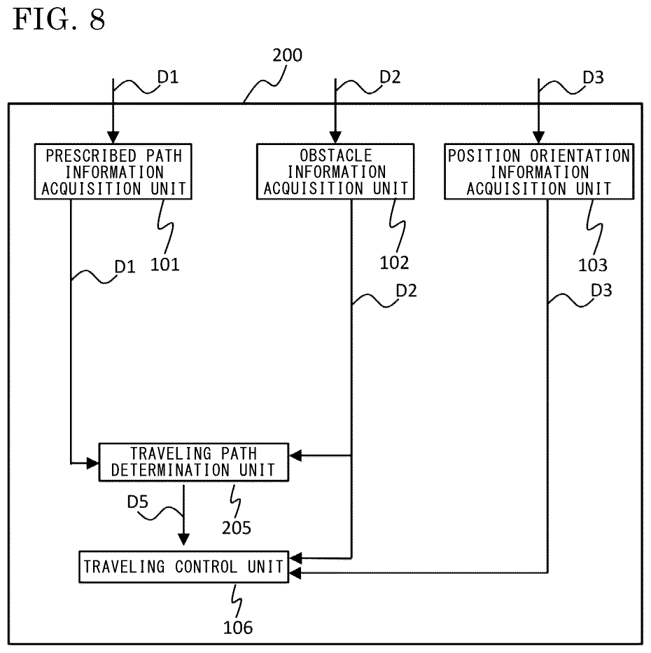

Next, the second embodiment of the present disclosure will be described with reference to FIG. 8 to FIG. 11. Unless otherwise specified, elements that are the same as or correspond to those in FIG. 1 to FIG. 7 are denoted by the same reference characters. The second embodiment is different from the first embodiment in that calculation of the reliability is omitted. Therefore, hereinafter, the difference from the first embodiment will be mainly described. FIG. 8 is a function block diagram showing a mobile object control device in the second embodiment.

A mobile object control device 200 is obtained by omitting the reliability calculation unit 104 from the mobile object control device 100. As a result of omitting the reliability calculation unit 104, the traveling path determination unit 105 of the first embodiment is replaced with a traveling path determination unit 205. The traveling path determination unit 205 receives the prescribed path information D1 and the obstacle information D2, and outputs the traveling path determination result D5 to the traveling control unit 106.

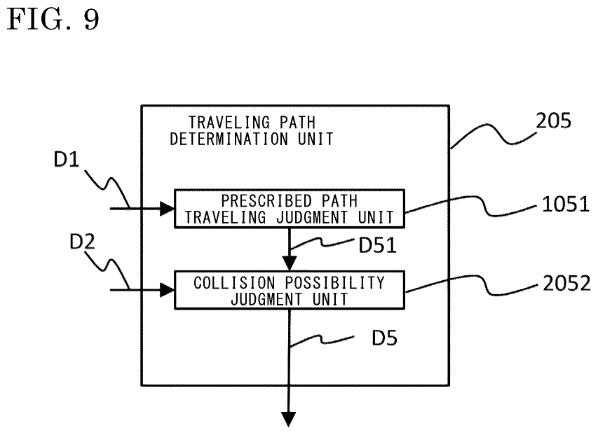

FIG. 9 is a function block diagram showing the traveling path determination unit according to the second embodiment. The traveling path determination unit 205 determines whether or not to switch the traveling path of the vehicle 91 from the prescribed path 92 to the prescribed-path-outside traveling path 96, as in the traveling path determination unit 105 of the first embodiment. Meanwhile, the traveling path determination unit 205 includes a collision possibility judgment unit 2052 instead of the collision possibility judgment unit 1052, and does not include the traveling path switchover determination unit 1053.

The collision possibility judgment unit 2052 receives the obstacle information D2 and the prescribed path traveling judgment result D51, and judges whether or not there is a possibility that the vehicle 91 traveling on the prescribed path 92 collides with the obstacle 95, on the basis of the obstacle information D2 and the prescribed path traveling judgment result D51. A specific method for the judgment is the same as in the collision possibility judgment unit 1052 of the first embodiment. If it is judged that there is a possibility of collision between the vehicle 91 and the obstacle 95, the collision possibility judgment unit 2052 determines to switch the traveling path of the vehicle 91 from the prescribed path 92 to the prescribed-path-outside traveling path 96, and if it is judged that there is no possibility of collision between the vehicle 91 and the obstacle 95, the collision possibility judgment unit 2052 determines to keep the traveling path of the vehicle 91 remaining the prescribed path 92. The collision possibility judgment unit 2052 outputs the determination result as the traveling path determination result D5 to the traveling control unit 106.

The other matters are the same as in the first embodiment.

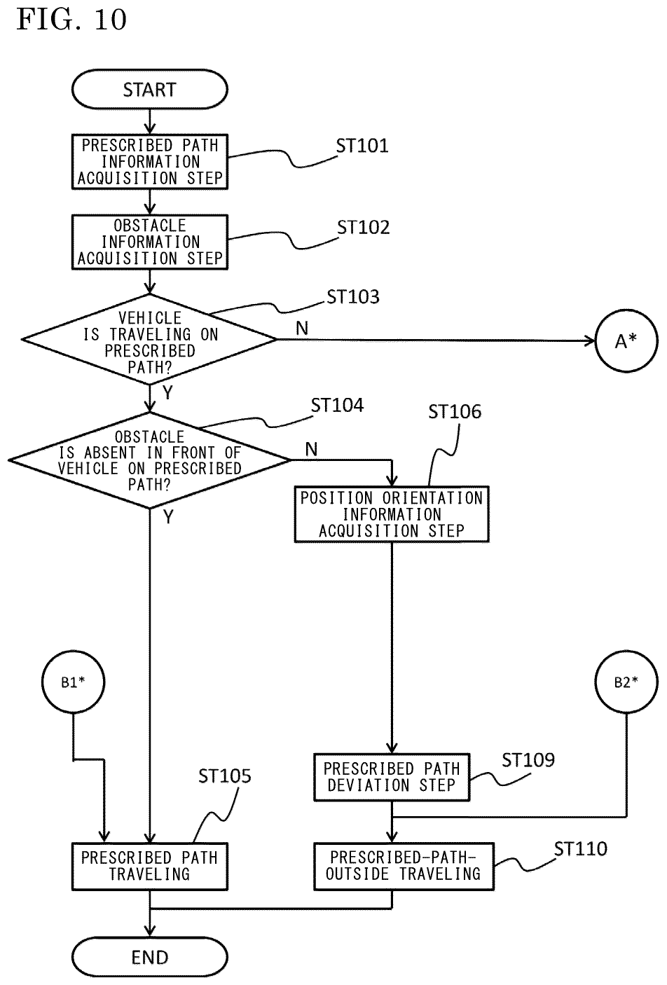

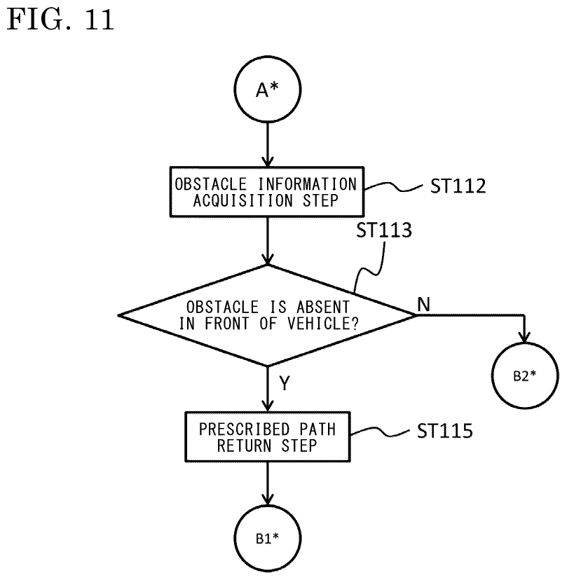

Next, operation will be described. FIG. 10 is a flowchart showing operation of the mobile object control device in the second embodiment. Also for the operation, a difference from the first embodiment will be mainly described. Terminals A*, B1*, B2* in FIG. 10 and FIG. 11 described later correspond to the terminals A, B1, B2 in FIG. 5 and FIG. 7. As described above, in the second embodiment, calculation of the reliability D4 is omitted. Accordingly, comparison between the reliability D4 and the threshold th1 is not performed. Therefore, if it is judged that an obstacle is present in front of the vehicle on the prescribed path in step ST104 (it is judged that there is a collision possibility), it is determined that the traveling path of the vehicle 91 is switched from the prescribed path 92 to the prescribed-path-outside traveling path 96, so as to perform prescribed-path-outside traveling. Thus, if the vehicle 91 is traveling on the prescribed path 92 and it is judged that the obstacle 95 is present in front of the vehicle 91 on the prescribed path in step ST104, the process proceeds to step ST106, step ST109, and step ST110 (so as to switch to prescribed-path-outside traveling).

FIG. 11 is a flowchart showing operation in the prescribed-path-outside traveling according to the second embodiment. In the second embodiment, similarly, calculation of the reliability D4* is also omitted in the prescribed-path-outside traveling, and accordingly, the prescribed-path-outside reliability calculation step and comparison between the reliability D4* and the threshold th1* are omitted. Therefore, if it is judged that the obstacle 95 is absent in front of the vehicle 91 in step ST113, the process proceeds to the prescribed path return step in step ST115.

The other matters are the same as in the first embodiment.

According to the second embodiment, for a vehicle traveling on a prescribed path, in a case where an obstacle is present on the prescribed path, the traveling path can be switched from the prescribed path to outside of the prescribed path, thus avoiding the obstacle. The reason therefor is the same as in the first embodiment.

### Third Embodiment

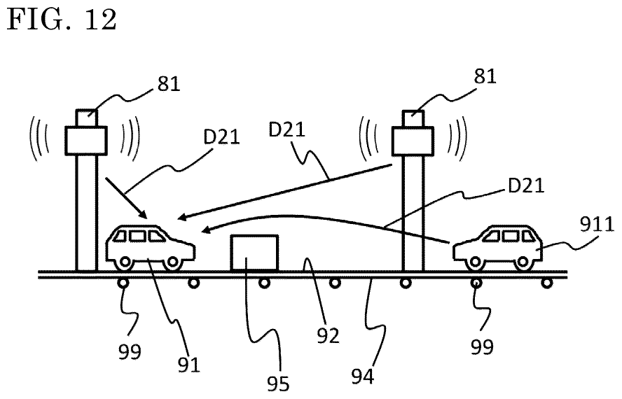

Next, the third embodiment of the present disclosure will be described with reference to FIG. 12 to FIG. 15. Unless otherwise specified, elements that are the same as or correspond to those in FIG. 1 to FIG. 11 are denoted by the same reference characters. The third embodiment relates to a mobile object control system and is different from the first embodiment in that obstacle information acquired from a thing other than the own vehicle is also used. Therefore, hereinafter, the difference from the first embodiment will be mainly described. FIG. 12 illustrates the outline of the mobile object control system in the third embodiment. Also in the third embodiment, the vehicle 91 as a control target normally travels on the prescribed path 92, as described above. Under the road surface of the prescribed path, the electromagnetic guide wire 94 and magnetic markers 99 used in traveling control of the vehicle 91 that performs prescribed path traveling are buried. The vehicle 91 is provided with the mobile object control device (not shown) as described in the first or second embodiment, and avoids the obstacle 95 on the prescribed path by the mobile object control device. At this time, whether or not the obstacle 95 is present in front of the vehicle 91 is judged, and this is also the same as in the first embodiment. In FIG. 12, only one vehicle 91 as a control target is shown, but there may be a plurality of vehicles 91.

Since the mobile object control device is mounted to the vehicle 91, in the first and second embodiments, information about the obstacle 95 (obstacle information D2) is acquired from only the vehicle 91. In the third embodiment, information about the obstacle 95 is acquired from multiple directions. That is, from a roadside unit 81 and another vehicle 911, obstacle information D21 is acquired from angles different from that of the vehicle 91 (to be exact, the obstacle information acquisition unit 102 of the mobile object control device mounted to the vehicle 91). The kinds of information included in the obstacle information D21 are the same as those in the obstacle information D2. Therefore, the roadside unit 81 and the other vehicle 911 have configurations corresponding to the obstacle information acquisition unit 102. The obstacle information D21 is transmitted to the mobile object control device of the vehicle 91 via wireless communication.

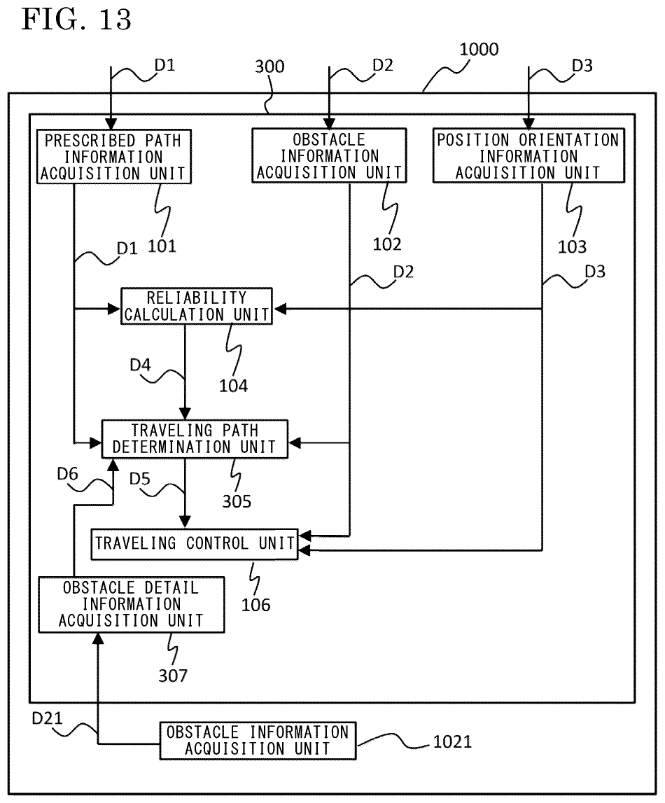

FIG. 13 is a function block diagram showing the mobile object control system in the third embodiment. A mobile object control system 1000 includes a mobile object control device 300, and an obstacle information acquisition unit 1021 (i.e., a second obstacle information acquisition unit) provided outside the mobile object control device 300. The obstacle information acquisition unit 1021 is an obstacle information acquisition unit that each of the roadside unit 81 and the other vehicle 911 has.

The mobile object control device 300 is mounted to the vehicle 91, and is obtained by adding an obstacle detail information acquisition unit 307 to the mobile object control device 100 of the first embodiment. As a result of adding the obstacle detail information acquisition unit 307, the traveling path determination unit 105 of the first embodiment is replaced with a traveling path determination unit 305. The obstacle detail information acquisition unit 307 may be added to the mobile object control device 200 of the second embodiment.

The obstacle detail information acquisition unit 307 collects the obstacle information D21 from the obstacle information acquisition unit 1021. The obstacle information D21 is information about the obstacle 95 as described above, but is acquired from angles different from that of the obstacle information D2 acquired by the obstacle information acquisition unit 102. The obstacle detail information acquisition unit 307 integrates the collected obstacle information D21 as obstacle detail information D6, and outputs the obstacle detail information D6 to the traveling path determination unit 305.

The obstacle detail information D6 is obtained by gathering pieces of obstacle information D21 acquired from multiple directions, and thus includes more information about the obstacle 95 than the obstacle information D2. For example, regarding the size of the obstacle 95 with respect to the traveling direction of the vehicle 91 on the prescribed path 92 (the depth-direction size as seen from the vehicle 91), only an estimated value can be acquired from the obstacle information D2 obtained from the vehicle 91. However, by looking at the obstacle 95 from another direction, the depth-direction size of the obstacle 95 can be directly acquired, whereby a more accurate size can be acquired. In addition, regarding the kind of the obstacle 95, even in a case where it is difficult to perform accurate identification and classification by the mobile object control device 300, it may be possible to perform identification and classification by the roadside unit 81 having the obstacle information acquisition unit 1021, or the like. In addition, it is considered that the obstacle detail information D6 has higher accuracy than the obstacle information D2 even if they are the same information. The obstacle information D2 is acquired from the traveling vehicle 91, and for example, the position information of the obstacle 95 changes at each time. On the other hand, in a case where the position information of the obstacle 95 is acquired by stationary means such as the roadside unit 81, the acquired position information is stable and has high accuracy.

In addition, there is a case where information about the obstacle 95 present at a blind spot position for the vehicle 91 can be acquired from the obstacle detail information D6. Further, there is a case where information about whether or not the obstacle 95 is moving can be acquired with high accuracy.

The obstacle information acquisition unit 1021 is provided to the roadside unit 81, the other vehicle 911, and the like, and is not particularly limited as long as information about the obstacle 95 can be acquired from an angle different from that of the obstacle information acquisition unit 102 and the acquired obstacle information D21 can be transmitted to the obstacle detail information acquisition unit 307. For example, an infrastructure other than a roadside unit, a pedestrian, the Internet, or a combination thereof is also applicable.

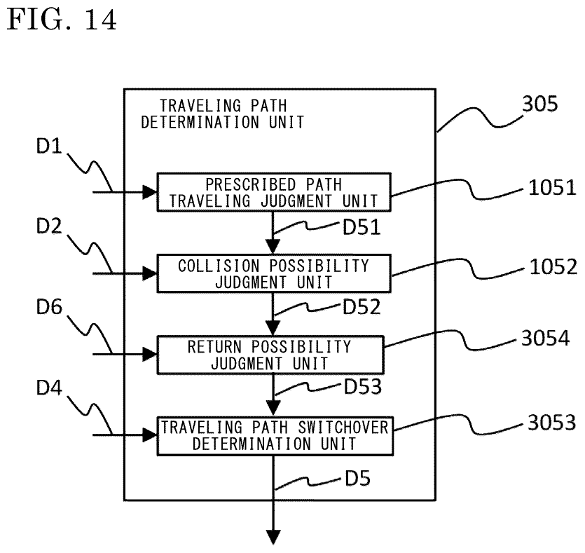

FIG. 14 is a function block diagram showing the traveling path determination unit according to the third embodiment. The traveling path determination unit 305 determines whether or not to switch the traveling path of the vehicle 91 from the prescribed path 92 to the prescribed-path-outside traveling path 96, as in the traveling path determination unit 105 of the first embodiment. Meanwhile, the traveling path determination unit 305 further includes a return possibility judgment unit 3054, and includes a traveling path switchover determination unit 3053 instead of the traveling path switchover determination unit 1053.

The return possibility judgment unit 3054 receives the obstacle detail information D6 and the collision possibility judgment result D52, and if it is judged that there is a possibility of collision between the vehicle 91 and the obstacle 95 in the collision possibility judgment result D52, the return possibility judgment unit 3054 judges whether or not it is possible for the vehicle 91 to return to the prescribed path 92 in a case of having caused the vehicle 91 to travel on the prescribed-path-outside traveling path 96 and avoid the obstacle 95, on the basis of the obstacle detail information D6. The return possibility judgment unit 3054 outputs the judgment result as a return possibility judgment result D53 to the traveling path switchover determination unit 3053. On the other hand, if it is judged that there is no possibility of collision between the vehicle 91 and the obstacle 95, the return possibility judgment unit 3054 sets the return possibility judgment result D53 so as not to switch the traveling path.

The traveling path switchover determination unit 3053 receives the reliability D4 and the return possibility judgment result D53, and determines whether or not to switch the traveling path of the vehicle 91 from the prescribed path 92 so as to cause the vehicle 91 to travel on the prescribed-path-outside traveling path 96. In a case where it is judged that there is a possibility of collision between the vehicle 91 and the obstacle 95, the reliability D4 is greater than the threshold th1, and it is possible for the vehicle 91 to return to the prescribed path 92 after performing prescribed-path-outside traveling, the traveling path switchover determination unit 3053 determines to switch the traveling path of the vehicle 91 from the prescribed path 92 to the prescribed-path-outside traveling path 96. If it is judged that there is no possibility of collision between the vehicle 91 and the obstacle 95, the reliability D4 is not greater than the threshold th1, or it is not possible for the vehicle 91 to return to the prescribed path 92 after performing prescribed-path-outside traveling, the traveling path switchover determination unit 3053 does not switch the traveling path of the vehicle 91 and keeps the traveling path of the vehicle 91 remaining the prescribed path 92. The traveling path switchover determination unit 3053 outputs the determination result as the traveling path determination result D5 to the traveling control unit 106.

The other matters are the same as in the first embodiment.

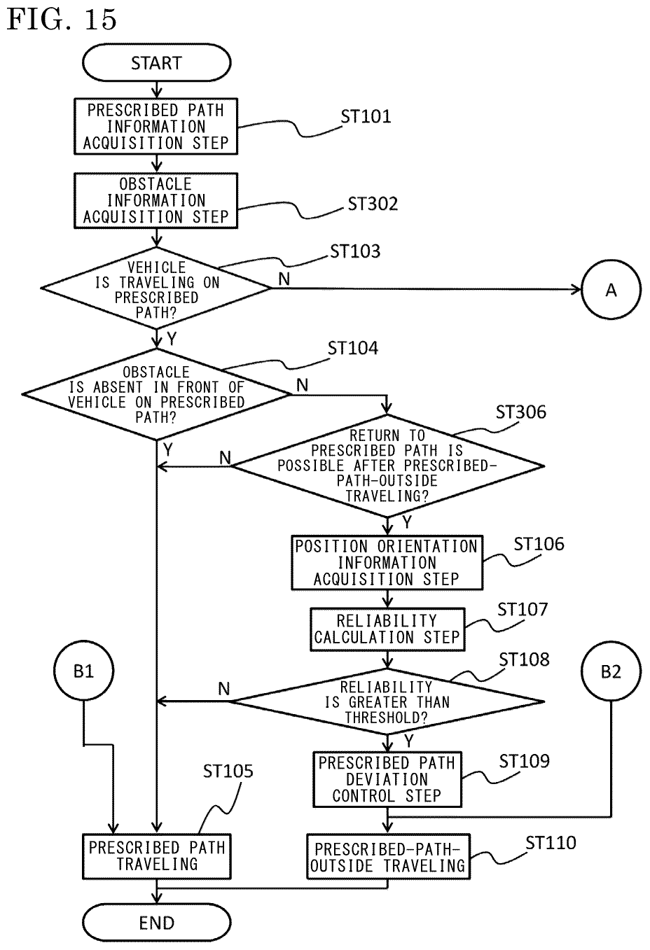

Next, operation will be described. FIG. 15 is a flowchart showing operation of the mobile object control system in the third embodiment. Also for the operation, a difference from the first embodiment will be mainly described. As described above, in the third embodiment, the obstacle detail information D6 is acquired. In addition, whether or not it is possible for the vehicle 91 to return to the prescribed path 92 in a case of having caused the vehicle 91 to travel on the prescribed-path-outside traveling path 96 and avoid the obstacle 95, is judged on the basis of the obstacle detail information D6, and the judgment result is taken into consideration in determination for the traveling path.

According to the difference between the first embodiment and the third embodiment described above, step ST102 in the first embodiment is replaced with step ST302. In the obstacle information acquisition step in step ST302, the obstacle information D2 and the obstacle detail information D6 are acquired.

After it is judged that the obstacle 95 is present in front of the vehicle 91 on the prescribed path in step ST104, whether or not it is possible to return to the prescribed path 92 in a case of having performed prescribed-path-outside traveling is judged on the basis of the obstacle detail information D6, thus obtaining the return possibility judgment result D53 (step ST306). If it is judged that it is possible to return to the prescribed path 92, the process proceeds to step ST106. If it is judged that it is not possible to return to the prescribed path 92, the process proceeds to step ST105. The subsequent process is the same as in the first embodiment. Thus, even in a case where the vehicle 91 is traveling on the prescribed path 92 and the obstacle 95 is present in front of the vehicle 91 on the prescribed path, if it is judged that it is not possible to return to the prescribed path 92 in a case of having performed prescribed-path-outside traveling, prescribed-path-outside traveling is not performed. In this case, collision between the vehicle 91 and the obstacle 95 is avoided by means such as stopping the vehicle 91, without changing the traveling path.

The other matters are the same as in the first embodiment.

According to the third embodiment, the same effects as in the first embodiment can be provided.

In addition, it is possible to prevent such a situation that the vehicle as a control target cannot return to the prescribed path in a case of having caused the vehicle to perform prescribed-path-outside traveling. More specifically, the mobile object control system includes an obstacle detail information acquisition unit which collects the obstacle information also from an angle different from that of the obstacle information acquisition unit provided to the vehicle as the control target and outputs the collected obstacle information as obstacle detail information. The traveling path determination unit judges whether or not it is possible for the vehicle to return to the prescribed path in a case of having caused the vehicle to perform the prescribed-path-outside traveling and avoid the obstacle, on the basis of the obstacle detail information, and if it is judged that it is not possible for the vehicle to return to the prescribed path, the traveling path determination unit determines not to switch the traveling path of the vehicle from the prescribed path. In this way, a return possibility to the prescribed path is confirmed before judgement for whether or not to deviate from the prescribed path. Thus, it is possible to prevent such a situation that the vehicle cannot return to the prescribed path in a case of having caused the vehicle to perform prescribed-path-outside traveling.

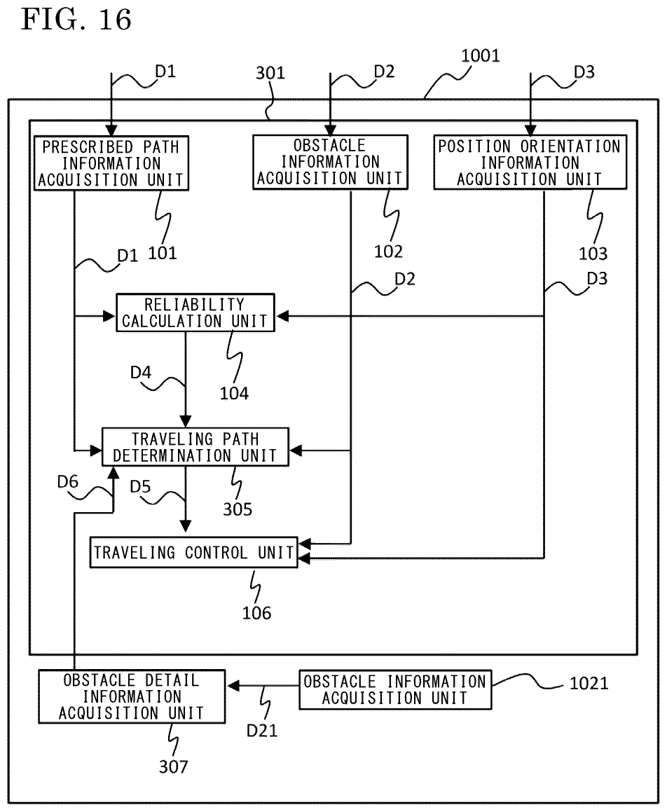

Next, a modification of the third embodiment will be described. FIG. 16 is a function block diagram showing a mobile object control system in the modification of the third embodiment. A mobile object control system 1001 is different from the mobile object control system 1000 and the mobile object control device 300 of the third embodiment in that the obstacle detail information acquisition unit 307 is provided outside the mobile object control device 301. The other matters are the same as in the third embodiment.

The obstacle detail information acquisition unit 307 only has to be able to collect, from the obstacle information acquisition unit 1021, the obstacle information D21 acquired from an angle different from that of the obstacle information D2, integrate the collected obstacle information D21 as the obstacle detail information D6, and transmit the obstacle detail information D6 to the traveling path determination unit 305. Therefore, the obstacle detail information acquisition unit 307 does not always need to be provided in the mobile object control device 301. As in the modification shown in FIG. 16, the obstacle detail information D6 generated outside the mobile object control device 301 may be used.

### Fourth Embodiment

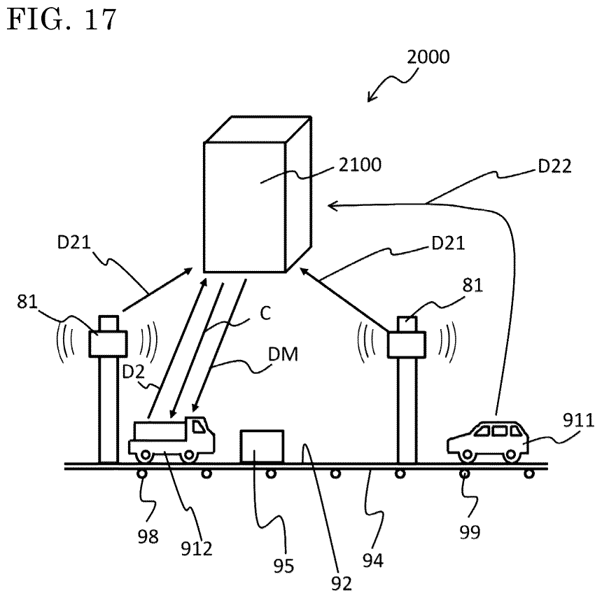

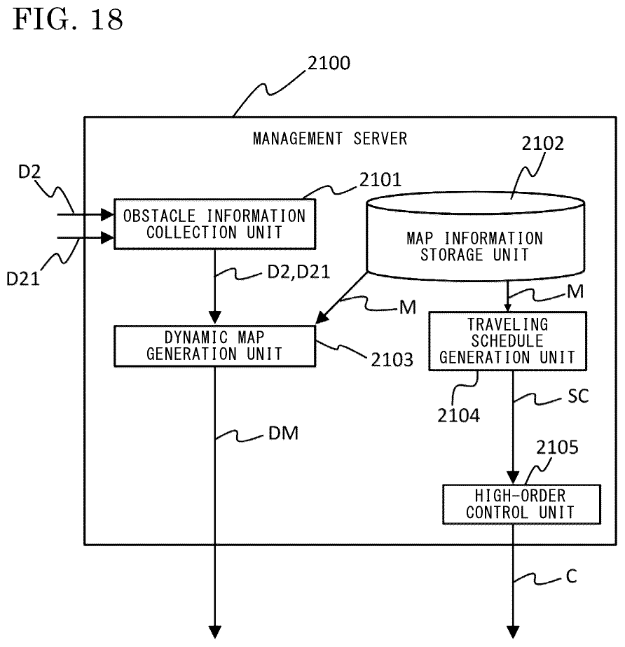

Next, the fourth embodiment of the present disclosure will be described with reference to FIG. 17 and FIG. 18. Unless otherwise specified, elements that are the same as or correspond to those in FIG. 1 to FIG. 16 are denoted by the same reference characters. In the fourth embodiment, the mobile object control system described in the third embodiment is applied to an automated transportation system. FIG. 17 shows the outline of the automated transportation system in the fourth embodiment. An automated transportation system 2000 includes the mobile object control device (not shown) described in the first to third embodiments (including the modification), and includes a vehicle 912 having a transportation function, and a management server 2100. The vehicle 912 is a vehicle as a control target in the fourth embodiment. Further, the automated transportation system 2000 includes the roadside unit 81 and the other vehicle 911, as in the third embodiment. The management server 2100 is capable of transmitting/receiving data to/from the vehicles 911, 912 and the roadside unit 81 via wireless communication, for example. The management server 2100 transmits a control command C to the vehicle 912 which is a vehicle as a control target, and receives the obstacle information D2 and the obstacle information D21 from the vehicle 912, the other vehicle 911, and the roadside unit 81. As with the vehicle 91 of the first embodiment, normally, the vehicle 912 also travels on the prescribed path 92, and in a case where there is a possibility of collision with the obstacle 95, whether or not to perform prescribed-path-outside traveling is determined by the mobile object control device. In FIG. 17, only one vehicle 912 as a control target is shown, but there may be a plurality of vehicles 912.

FIG. 18 is a function block diagram showing the management server according to the fourth embodiment. The management server 2100 includes an obstacle information collection unit 2101, a map information storage unit 2102, a dynamic map generation unit 2103, a traveling schedule generation unit 2104, and a high-order control unit 2105.

The obstacle information collection unit 2101 collects the obstacle information D2, D21 by receiving the obstacle information D2 from the vehicle 912 and the obstacle information D21 from the roadside unit 81 and the vehicle 911, and outputs the collected obstacle information D2, D21 to the dynamic map generation unit 2103.

The map information storage unit 2102 stores map information for a site where the automated transportation system 2000 is used, e.g., in a factory. The map information is static map information, and includes information about arrangement of the prescribed path 92 on which the vehicle 912 travels, the position where a material transported by the automated transportation system 2000, or the like, is placed, an entrance/exit of the site, and arrangement of a passage through which a person or the like passes. The map information storage unit 2102 outputs map data M indicating the above map information, to the dynamic map generation unit 2103 and the traveling schedule generation unit 2104, as necessary.

The dynamic map generation unit 2103 combines the obstacle information D2, D21 acquired from the obstacle information collection unit 2101 and the map data M acquired from the map information storage unit 2102, to generate a dynamic map DM. The dynamic map DM is dynamic map information in which data about the obstacle 95 at the time of the generation is reflected in the map data M. Since the dynamic map DM includes the obstacle information D2, D21, obstacle information acquired from multiple directions is reflected. That is, information similar to the obstacle detail information D6 described in the third embodiment is included in the dynamic map DM. The dynamic map generation unit 2103 transmits the generated dynamic map DM to the vehicle 912.

The traveling schedule generation unit 2104 receives the map data M and generates a traveling schedule SC for the vehicle 912 on the basis of the map data M. As described above, information about arrangement of the prescribed path 92 and the like are included in the map data M. In general, in the automated transportation system, a plurality of transportation vehicles (corresponding to the vehicle 912) travel on a plurality of prescribed paths 92. The traveling schedule generation unit 2104 determines which transportation vehicle is to travel and on which prescribed path 92 the transportation vehicle is to travel in a certain time period, and the like, on the basis of the map data M, to generate the traveling schedule SC for the vehicle 912. In a case where there are a plurality of vehicles 912, the traveling schedules SC corresponding to the respective vehicles 912 are generated. The traveling schedule generation unit 2104 outputs the generated traveling schedule SC to the high-order control unit 2105.

The high-order control unit 2105 is for generating the control command C for the vehicle 912, and generates the control command C according to the traveling schedule SC. Thus, the vehicle 912 travels in accordance with the traveling schedule SC. In a case where there are a plurality of vehicles 912, there are traveling schedules SC corresponding to the respective vehicles 912, and therefore the control commands C are also generated correspondingly to the respective vehicles 912. The high-order control unit 2105 transmits the generated control command C to the vehicle 912.

The vehicle 912 travels on the prescribed path 92 in accordance with the traveling schedule SC on the basis of the control command C, and if the obstacle 95 is present on the prescribed path, the vehicle 912 performs prescribed-path-outside traveling so as to avoid the obstacle 95, by the mobile object control device mounted to the vehicle 912. At this time, judgment for whether or not it is possible to return to the prescribed path 92, and setting for the prescribed-path-outside traveling path 96, may be performed by referring to the dynamic map DM. In a case of performing prescribed-path-outside traveling, a delay from the traveling schedule SC might occur. Therefore, feedback for reporting the own-vehicle position may be transmitted from the vehicle 912 to the management server 2100, and the management server 2100 may correct the traveling schedule SC in accordance with the feedback. In a case where the traveling schedule SC is corrected, the control command C might also be changed. In this case, a new control command C is transmitted from the management server 2100 to the vehicle 912.

In the fourth embodiment, the example in which the mobile object control system of the third embodiment is applied to the automated transportation system has been described. However, it is also possible to form an automated transportation system to which the mobile object control device described in the first or second embodiment is applied. In this case, the management server 2100 may generate the control command C so that the vehicle 91 travels in accordance with the traveling schedule SC. That is, the obstacle information collection unit 2101 and the dynamic map generation unit 2103 can be omitted from the management server 2100. In addition, if the traveling schedule SC can be generated without the map data M, the map information storage unit 2102 can also be omitted.

According to the fourth embodiment, the same effects as in the third embodiment can be provided for a transportation vehicle used in the automated transportation system.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### Additional Note 1

A mobile object control device comprising:
a prescribed path information acquisition unit which acquires prescribed path information indicating whether or not a mobile object as a control target is traveling on a prescribed path;
an obstacle information acquisition unit which acquires obstacle information which is information about an obstacle including presence/absence of the obstacle on the prescribed path;
a position orientation information acquisition unit which acquires position orientation information indicating a position and an orientation of the mobile object; and
a traveling path determination unit which judges whether or not the mobile object is traveling on the prescribed path, on the basis of the prescribed path information, and judges whether or not there is a possibility that the mobile object collides with the obstacle, and then, if it is judged that there is the possibility of the collision, determines whether or not to switch a traveling path of the mobile object from the prescribed path so as to cause the mobile object to travel on a traveling path other than the prescribed path.

### Additional Note 2

The mobile object control device according to additional note 1, further comprising a reliability calculation unit which calculates a reliability of the position orientation information on the basis of a relationship between the position of the mobile object and a position of the prescribed path, wherein
if the reliability is greater than a predetermined value, the traveling path determination unit determines to cause the mobile object to travel on the other traveling path, and if the reliability is not greater than the predetermined value, the traveling path determination unit determines to cause the mobile object to travel on the prescribed path, and
in a case of causing the mobile object to travel on the other traveling path as a result of the determination by the traveling path determination unit, traveling of the mobile object is controlled on the basis of the position orientation information.

### Additional Note 3

The mobile object control device according to additional note 2, wherein
the reliability calculation unit calculates the reliability on the basis of a difference between the position of the mobile object based on the position orientation information and the position of the prescribed path based on the prescribed path information.

### Additional Note 4

The mobile object control device according to additional note 3, wherein
the position orientation information acquisition unit acquires the position orientation information from positioning information by a global navigation satellite system, and
during traveling of the mobile object on the other traveling path, the reliability calculation unit calculates the reliability on the basis of at least one of a number of satellites of the global navigation satellite system, DOP, position error, orientation error, and an S/N ratio of a navigation signal of the global navigation satellite system.

### Additional Note 5

The mobile object control device according to any one of additional notes 1 to 4, wherein
the obstacle information includes information about movement of the obstacle.

### Additional Note 6

A mobile object control system comprising:
the mobile object control device according to any one of additional notes 1 to 5, which is provided to a mobile object as a control target;
a second obstacle information acquisition unit which acquires the obstacle information from an angle different from that of the obstacle information acquisition unit provided to the mobile object control device; and
an obstacle detail information acquisition unit which collects the obstacle information acquired by the second obstacle information acquisition unit and outputs the collected obstacle information as obstacle detail information, wherein
the traveling path determination unit judges whether or not it is possible for the mobile object to return to the prescribed path in a case of having caused the mobile object to travel on the other traveling path and avoid the obstacle, on the basis of the obstacle detail information, and if it is judged that it is not possible for the mobile object to return to the prescribed path, determines the prescribed path to be the traveling path of the mobile object.

### Additional Note 7

An automated transportation system comprising:
the mobile object control device according to any one of additional notes 1 to 5, which is provided to a mobile object as a control target, the mobile object having a transportation function; and
a management server which generates a traveling schedule for the mobile object and includes a high-order control unit which transmits a control command according to the traveling schedule, to the mobile object.

### Additional Note 8

The automated transportation system according to additional note 7, further comprising:
a second obstacle information acquisition unit which acquires the obstacle information from an angle different from that of the obstacle information acquisition unit provided to the mobile object control device; and
an obstacle detail information acquisition unit which collects the obstacle information acquired by the second obstacle information acquisition unit and outputs the collected obstacle information as obstacle detail information, wherein
the traveling path determination unit judges whether or not it is possible for the mobile object to return to the prescribed path in a case of having caused the mobile object to travel on the other traveling path and avoid the obstacle, on the basis of the obstacle detail information, and if it is judged that it is not possible for the mobile object to return to the prescribed path, determines the prescribed path to be the traveling path of the mobile object.

### Additional Note 9

A mobile object control method comprising:
a prescribed path information acquisition step of acquiring prescribed path information indicating whether or not a mobile object as a control target is traveling on a prescribed path;
an obstacle information acquisition step of acquiring obstacle information which is information about an obstacle including presence/absence of the obstacle on the prescribed path;
a position orientation information acquisition step of acquiring position orientation information indicating a position and an orientation of the mobile object; and
a traveling path determination step of judging whether or not the mobile object is traveling on the prescribed path, on the basis of the prescribed path information, and judging whether or not there is a possibility that the mobile object collides with the obstacle, and then, if it is judged that there is the possibility of the collision, determining whether or not to switch a traveling path of the mobile object from the prescribed path so as to cause the mobile object to travel on a traveling path other than the prescribed path.

### Additional Note 10

The mobile object control method according to additional note 9, further comprising a reliability calculation step of calculating a reliability of the position orientation information on the basis of a relationship between the position of the mobile object and a position of the prescribed path, wherein
in the traveling path determination step, if the reliability is greater than a predetermined value, it is determined that the mobile object is caused to travel on the other traveling path, and if the reliability is not greater than the predetermined value, it is determined that the mobile object is caused to travel on the prescribed path, and
in a case of causing the mobile object to travel on the other traveling path as a result of the determination in the traveling path determination step, traveling of the mobile object is controlled on the basis of the position orientation information.

### Additional Note 11

The mobile object control method according to additional note 10, wherein
in the reliability calculation step, the reliability is calculated on the basis of a difference between the position of the mobile object based on the position orientation information and the position of the prescribed path based on the prescribed path information.

### Additional Note 12

The mobile object control method according to additional note 11, wherein
in the position orientation information acquisition step, the position orientation information is acquired from positioning information by a global navigation satellite system, and
during traveling of the mobile object on the other traveling path, the reliability is calculated on the basis of at least one of a number of satellites of the global navigation satellite system, DOP, position error, orientation error, and an S/N ratio of a navigation signal of the global navigation satellite system.

### Additional Note 13

The mobile object control method according to any one of additional notes 9 to 12, wherein
the obstacle information includes information about movement of the obstacle.

### Additional Note 14

The mobile object control method according to any one of additional notes 9 to 13, wherein
the obstacle information is collected from an angle different from a direction from the mobile object, and the collected obstacle information is used as obstacle detail information, and
in the traveling path determination step, whether or not it is possible for the mobile object to return to the prescribed path in a case of having caused the mobile object to travel on the other traveling path and avoid the obstacle, is judged on the basis of the obstacle detail information, and if it is judged that it is not possible for the mobile object to return to the prescribed path, the prescribed path is determined to be the traveling path of the mobile object.

### DESCRIPTION OF THE REFERENCE CHARACTERS

81 roadside unit
91, 911, 912 vehicle
92 prescribed path
95 obstacle
96 prescribed-path-outside traveling path
100, 200, 300, 301 mobile object control device
101 prescribed path information acquisition unit
102, 1021 obstacle information acquisition unit
103 position orientation information acquisition unit
104 reliability calculation unit
105, 205, 305 traveling path determination unit
106 traveling control unit
307 obstacle detail information acquisition unit
1000, 1001 mobile object control system
1051 prescribed path traveling judgment unit
1052, 2052 collision possibility judgment unit
1053, 3053 traveling path switchover determination unit
2000 automated transportation system
2100 management server
2101 obstacle information collection unit
2103 dynamic map generation unit
2104 traveling schedule generation unit
2105 high-order control unit
3054 return possibility judgment unit
C control command
D1 prescribed path information
D2, D21 obstacle information
D3 position orientation information
D4 reliability
D5 traveling path determination result
D51 prescribed path traveling judgment result
D52 collision possibility judgment result
D53 return possibility judgment result
D6 obstacle detail information
DM dynamic map

What is claimed is:

1. A mobile object control device comprising:
a processor for executing a program; and
a memory or a hard disk for storing the program, wherein
the following operation is performed by the program executed by the processor,
acquiring prescribed path information indicating whether or not a mobile object as a control target is traveling on a prescribed path;
acquiring obstacle information which is information about an obstacle including presence/absence of the obstacle on the prescribed path;
acquiring position orientation information indicating a position and an orientation of the mobile object;
judging whether or not the mobile object is traveling on the prescribed path, on the basis of the prescribed path information;
judging whether or not there is a possibility that the mobile object has a collision with the obstacle; and,
determining whether or not to switch a traveling path of the mobile object from the prescribed path so as to cause the mobile object to travel on a traveling path other than the prescribed path if it is judged that there is the possibility of the collision.

2. The mobile object control device according to claim 1, wherein
the following operation is further performed by the program executed by the processor,
calculating a reliability of the position orientation information on the basis of a relationship between the position of the mobile object and a position of the prescribed path;
determining to cause the mobile object to travel on the other traveling path if the reliability is greater than a predetermined value; and,
determining to cause the mobile object to travel on the prescribed path if the reliability is not greater than the predetermined value, wherein
traveling of the mobile object is controlled on the basis of the position orientation information in a case of causing the mobile object to travel on the other traveling path as a result of the determination.

3. The mobile object control device according to claim 2, wherein
the reliability is calculated on the basis of a difference between the position of the mobile object based on the position orientation information and the position of the prescribed path based on the prescribed path information.

4. The mobile object control device according to claim 3, wherein
the position orientation information is acquired from positioning information by a global navigation satellite system, and
during traveling of the mobile object on the other traveling path, the reliability is calculated on the basis of at least one of a number of satellites of the global navigation satellite system, DOP, position error, orientation error, and an S/N ratio of a navigation signal of the global navigation satellite system.

5. The mobile object control device according to claim 1, wherein
the obstacle information includes information about movement of the obstacle.

6. The mobile object control device according to claim 2, wherein
the obstacle information includes information about movement of the obstacle.

7. The mobile object control device according to claim 3, wherein
the obstacle information includes information about movement of the obstacle.

8. The mobile object control device according to claim 4, wherein
the obstacle information includes information about movement of the obstacle.

9. A mobile object control system comprising:
the mobile object control device according to claim 1, which is provided to a mobile object as a control target;
an obstacle information acquisition circuitry which acquires the obstacle information from an angle different from that of the mobile object control device; and
an obstacle detail information acquisition circuitry which collects the obstacle information acquired by the obstacle information acquisition circuitry and outputs the collected obstacle information as obstacle detail information, wherein
the mobile object control device judges whether or not it is possible for the mobile object to return to the prescribed path in a case of having caused the mobile object to travel on the other traveling path and avoid the obstacle, on the basis of the obstacle detail information, and if it is judged that it is not possible for the mobile object to return to the prescribed path, determines the prescribed path to be the traveling path of the mobile object.

10. An automated transportation system comprising:
the mobile object control device according to claim 1, which is provided to a mobile object as a control target, the mobile object having a transportation function; and
a management server which generates a traveling schedule for the mobile object and includes a high-order control circuitry which transmits a control command according to the traveling schedule, to the mobile object.

11. The automated transportation system according to claim 10, further comprising:
an obstacle information acquisition circuitry which acquires the obstacle information from an angle different from that of the mobile object control device; and
an obstacle detail information acquisition circuitry which collects the obstacle information acquired by the obstacle information acquisition circuitry and outputs the collected obstacle information as obstacle detail information, wherein
the mobile object control device judges whether or not it is possible for the mobile object to return to the prescribed path in a case of having caused the mobile object to travel on the other traveling path and avoid the obstacle, on the basis of the obstacle detail information, and if it is judged that it is not possible for the mobile object to return to the prescribed path, determines the prescribed path to be the traveling path of the mobile object.

12. A mobile object control method comprising:
a prescribed path information acquisition step of acquiring prescribed path information indicating whether or not a mobile object as a control target is traveling on a prescribed path;
an obstacle information acquisition step of acquiring obstacle information which is information about an obstacle including presence/absence of the obstacle on the prescribed path;
a position orientation information acquisition step of acquiring position orientation information indicating a position and an orientation of the mobile object; and
a traveling path determination step of judging whether or not the mobile object is traveling on the prescribed path, on the basis of the prescribed path information, and judging whether or not there is a possibility that the mobile object has a collision with the obstacle, and then, if it is judged that there is the possibility of the collision, determining whether or not to switch a traveling path of the mobile object from the prescribed path so as to cause the mobile object to travel on a traveling path other than the prescribed path.

13. The mobile object control method according to claim 12, further comprising a reliability calculation step of calculating a reliability of the position orientation information on the basis of a relationship between the position of the mobile object and a position of the prescribed path, wherein
in the traveling path determination step, if the reliability is greater than a predetermined value, it is determined that the mobile object is caused to travel on the other traveling path, and if the reliability is not greater than the predetermined value, it is determined that the mobile object is caused to travel on the prescribed path, and
in a case of causing the mobile object to travel on the other traveling path as a result of the determination in the traveling path determination step, traveling of the mobile object is controlled on the basis of the position orientation information.

14. The mobile object control method according to claim 13, wherein
in the reliability calculation step, the reliability is calculated on the basis of a difference between the position of the mobile object based on the position orientation information and the position of the prescribed path based on the prescribed path information.

15. The mobile object control method according to claim 14, wherein
in the position orientation information acquisition step, the position orientation information is acquired from positioning information by a global navigation satellite system, and
during traveling of the mobile object on the other traveling path, the reliability is calculated on the basis of at least one of a number of satellites of the global navigation satellite system, DOP, position error, orientation error, and an S/N ratio of a navigation signal of the global navigation satellite system.

16. The mobile object control method according to claim 12, wherein
the obstacle information includes information about movement of the obstacle.

17. The mobile object control method according to claim 13, wherein
the obstacle information includes information about movement of the obstacle.

18. The mobile object control method according to claim 12, wherein
the obstacle information is collected from an angle different from that of the mobile object, and the collected obstacle information is used as obstacle detail information, and
in the traveling path determination step, whether or not it is possible for the mobile object to return to the prescribed path in a case of having caused the mobile object to travel on the other traveling path and avoid the obstacle, is judged on the basis of the obstacle detail information, and if it is judged that it is not possible for the mobile object to return to the prescribed path, the prescribed path is determined to be the traveling path of the mobile object.

19. The mobile object control method according to claim 13, wherein
the obstacle information is collected from an angle different from that of the mobile object, and the collected obstacle information is used as obstacle detail information, and
in the traveling path determination step, whether or not it is possible for the mobile object to return to the prescribed path in a case of having caused the mobile object to travel on the other traveling path and avoid the obstacle, is judged on the basis of the obstacle detail information, and if it is judged that it is not possible for the mobile object to return to the prescribed path, the prescribed path is determined to be the traveling path of the mobile object.

20. The mobile object control method according to claim 14, wherein
the obstacle information is collected from an angle different from that of the mobile object, and the collected obstacle information is used as obstacle detail information, and
in the traveling path determination step, whether or not it is possible for the mobile object to return to the prescribed path in a case of having caused the mobile object to travel on the other traveling path and avoid the obstacle, is judged on the basis of the obstacle detail information, and if it is judged that it is not possible for the mobile object to return to the prescribed path, the prescribed path is determined to be the traveling path of the mobile object.
